(19) United States
(12) Patent Application Publication
(10) Pub. No.: US 2013/0170133 A1
(43) Pub. Date: Jul. 4, 2013

(54) HEAT DISSIPATING APPARATUS

(71) Applicant: SHUANG FU, Shenzhen City (CN)

(72) Inventor: SHUANG FU, Shenzhen City (CN)

(21) Appl. No.: 13/653,455

(22) Filed: Oct. 17, 2012

(30) Foreign Application Priority Data
Dec. 28, 2011 (CN) 201110447310.4

(51) Int. Cl. F28D 15/02; G06F 1/20

(52) U.S. Cl. 361/679.47; 165/104.21

(57) ABSTRACT

A heat dissipating apparatus includes a base, a first fin assembly, a second fin assembly, and at least one heat pipe. The base includes a top surface and a bottom surface, the bottom surface makes contact with an electronic heat-generating component. The first fin assembly is disposed on the top surface of the base. The second fin assembly is separate from the first fin assembly. The at least one heat pipe includes a first contacting portion in contact with the base and a second contacting portion in contact with the second fin assembly.

### REFERENCE TO RELATED APPLICATIONS

This application claims all benefits accruing under 35 U.S.C. §119 from China Patent Application No. 201110447310.4, filed on Dec. 28, 2011 in the State Intellectual Property Office of China, the contents of the China application are hereby incorporated by reference.

### BACKGROUND

1. Technical Field

The present disclosure generally relates to heat dissipating apparatuses, and particularly relates to a heat dissipating apparatus having two spaced fin assemblies.

2. Description of Related Art

Electronic components, such as central processing units (CPUs) in computers, generate a lot of heat during operations. Excess heat may cause deterioration in the operational stability of the electronic components and may damage the electronic components. Thus, excess heat must be removed quickly to maintain an acceptable operating temperature of the electronic components in the computer. One method for removing heat from an electronic component is by mounting a heat dissipating apparatus on the electronic component. However, the dissipating apparatus of related art may be inadequate to satisfy the ever-increasing demand for heat dissipation.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of a heat dissipating apparatus in accordance with an embodiment.

FIG. 2 is an assembled view of the heat dissipating apparatus of FIG. 1.

FIG. 3 is an isometric view of a host computer.

FIG. 4 is an isometric view of the host computer of FIG. 3, in which the heating dissipating apparatus of FIG. 2 is installed.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

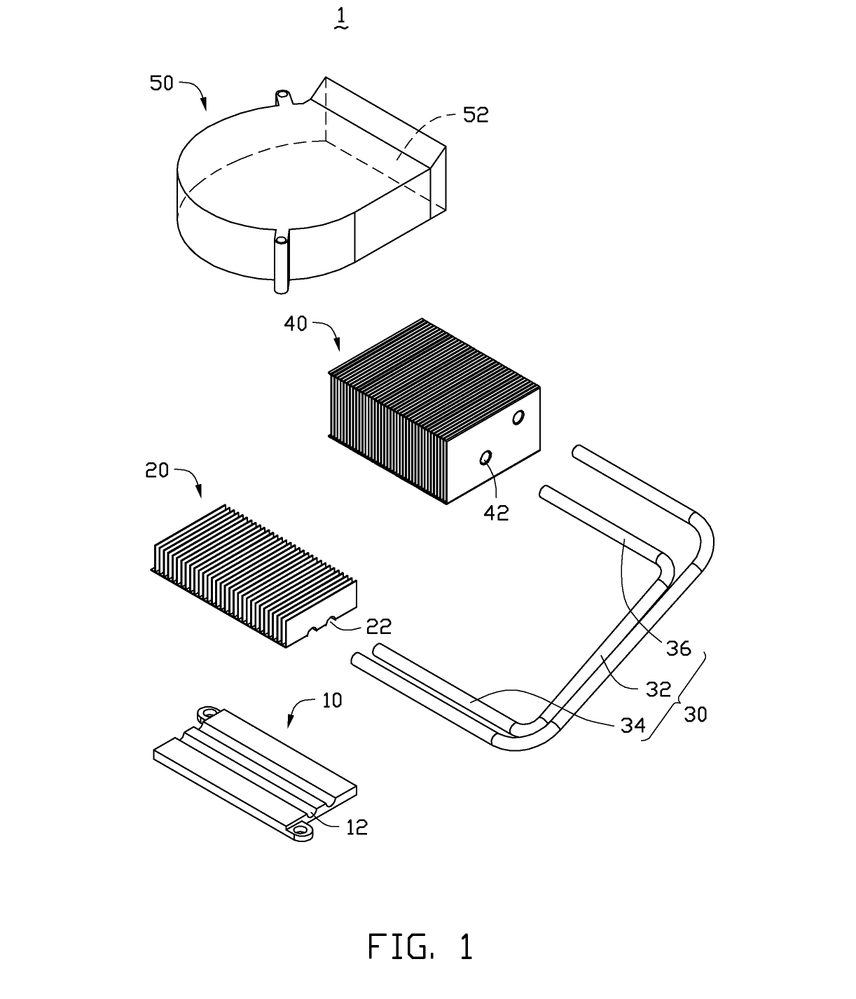

FIG. 1 shows a heat dissipating apparatus 1 in accordance with an embodiment. The heat dissipating apparatus 1 includes a base 10, a first fin assembly 20, at least one heat pipe 30, a second fin assembly 40, and a unidirectional fan module 50.

The base 10 includes a bottom surface and a top surface. The bottom surface of the base 10 may contact a heat delivery surface of an electronic heat-generating component (not shown), such as a central processing unit (CPU) or a graphic processing unit (GPU), and take heat from the heat-generating component. The base 10 defines at least one receiving groove 12 on the top surface. The number of the at least one receiving groove 12 is equal to the number of the at least one heat pipe 30. Each of the at least one receiving groove 12 extends lengthwise along the base 10 and across the top surface of the base 10.

The first fin assembly 20 includes a plurality of parallel first fins. The first fin assembly 20 defines at least one cutout groove 22 in its bottom surface which matches the internal shape of the at least one receiving groove 12. The number of the at least one cutout groove 22 is equal to the number of the at least one receiving groove 12. Each of the at least one cutout groove 22 extends along a longer side of the first fin assembly 20 and is perpendicular to each of the plurality of first fins. The shape of the bottom surface of the first fin assembly 20 is substantially the same as the shape of the top surface of the base 10.

Each of the at least one heat pipe 30 is U-shaped and includes a connecting portion 32, a first contacting portion 34, and a second contacting portion 36. The first contacting portion 34 and the second contacting portion 36 are perpendicular to the connecting portion 32 and extend from two opposite ends of the connecting portion 32. The first contacting portion 34 and the second contacting portion 36 are parallel to each other. The connecting portion 32, the first contacting portion 34, and the second contacting portion 36 are substantially located in a same plane.

The second fin assembly 40 includes a plurality of second fins that are parallel to each other. The second fin assembly 40 defines at least one through hole 42. Each of the at least one through hole 42 extends through the second fin assembly 40. The number of the at least one through hole 42 is equal to the number of the at least one heat pipe 30. Each of the at least one through hole 42 extends along the longer dimension of the second fin assembly 40 and is perpendicular to each of the plurality of second fins. The height of the second fin assembly 40 may be greater than that of the first fin assembly 20.

The unidirectional fan module 50 includes an air outlet 52. The unidirectional fan module 50 may generate an airflow and output the airflow though the air outlet 52. The height of the air outlet 52 is substantially the same as the height of the second fin assembly 40.

In the embodiment shown in FIG. 1, the heat dissipating apparatus 1 includes two heat pipes of the at least one heat pipe 30. The base 10 defines two receiving grooves of the at least one receiving groove 12. The two receiving grooves 12 are arranged in the middle of the top surface of the base 10 and are parallel to each other. The first fin assembly 20 defines two cutout grooves of the at least one cutout groove 22. The second fin assembly 40 defines two through holes of the at least one through hole 42. The two through holes 42 are parallel to each other.

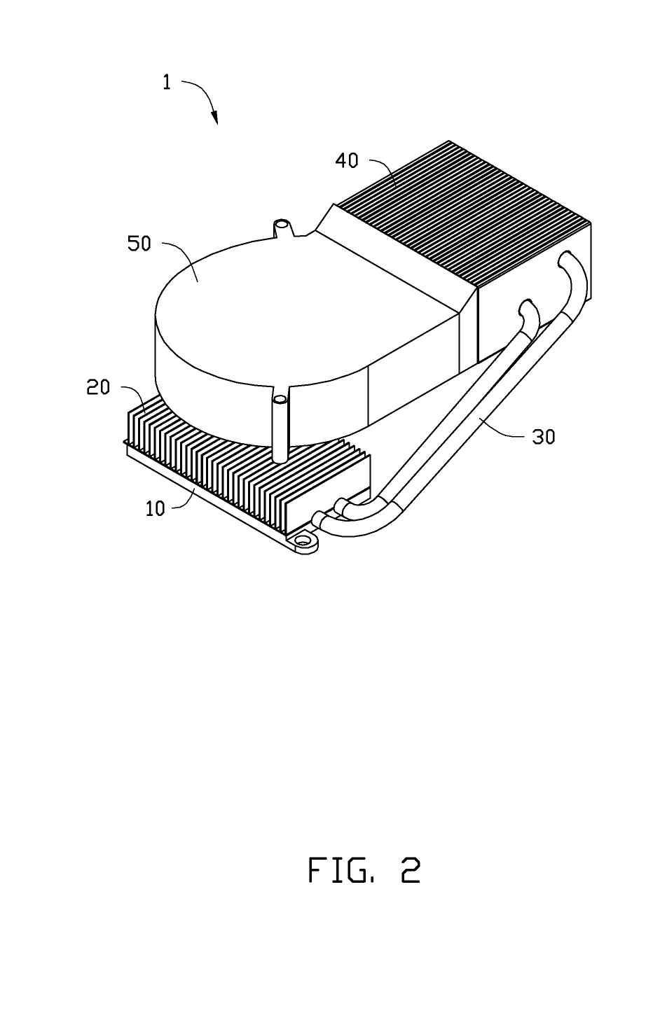

Referring to FIG. 2, in assembly, the first contacting portion 34 of each of the at least one heat pipe 30 is received in corresponding one of the at least one receiving groove 12 of the base 10. The first fin assembly 20 is positioned above the base 10. The at least one cutout groove 22 of the first fin assembly 20 is aligned with the at least one receiving groove 12 of the base 10. The first fin assembly 20 is moved towards the base 10 until the bottom surface of the first fin assembly 20 contacts the top surface of the base 10. Each of the at least one receiving groove 12 together with corresponding one of the at least one cutout groove 22 define a receiving hole and the first contacting portion 34 of corresponding one of the at least one heat pipe 30 is received in the receiving hole. Thus, the first contacting portion 34 of each of the at least one heat pipe 30 is in contact with both the base 10 and the first fin assembly 20.

The second contacting portion 36 of each of the at least one heat pipe 30 is inserted into corresponding one of the at least one through hole 42 of the second fin assembly 40. The diameter of the cross section of the second contacting portion 36 is substantially the same as that of the at least one through hole 42 so that the second contacting portion 36 is in contact with the inner surface(s) of the at least one through hole 42 when the second contacting portion 36 is received in the at least one through hole 42.

The first fin assembly 20 and the second fin assembly 40 are separate from each other. The second fin assembly 40 is located in a horizontal position higher than the first fin assembly 20. The plane of each of the at least one heat pipe 30 is inclined upward from the top surface of the base 10.

The unidirectional fan module 50 is coupled to the second fin assembly 40. The air outlet 52 of the unidirectional fan module 50 faces to the second fin assembly 40 and is connected to a side of the second fin assembly 40. Thus, the airflow from the unidirectional fan module 50 blows towards and through the second fin assembly 14 through the air outlet 52 and removes heat from the second fin assembly 40. The unidirectional fan module 50 is above the first fin assembly 20. There is a space between the unidirectional fan module 50 and the first fin assembly 20.

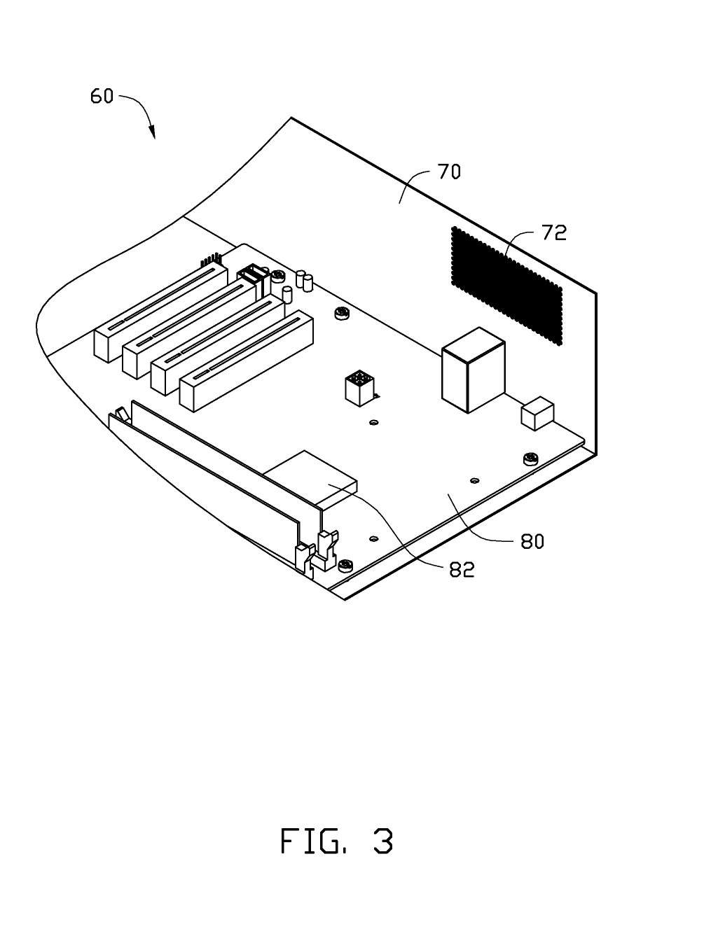

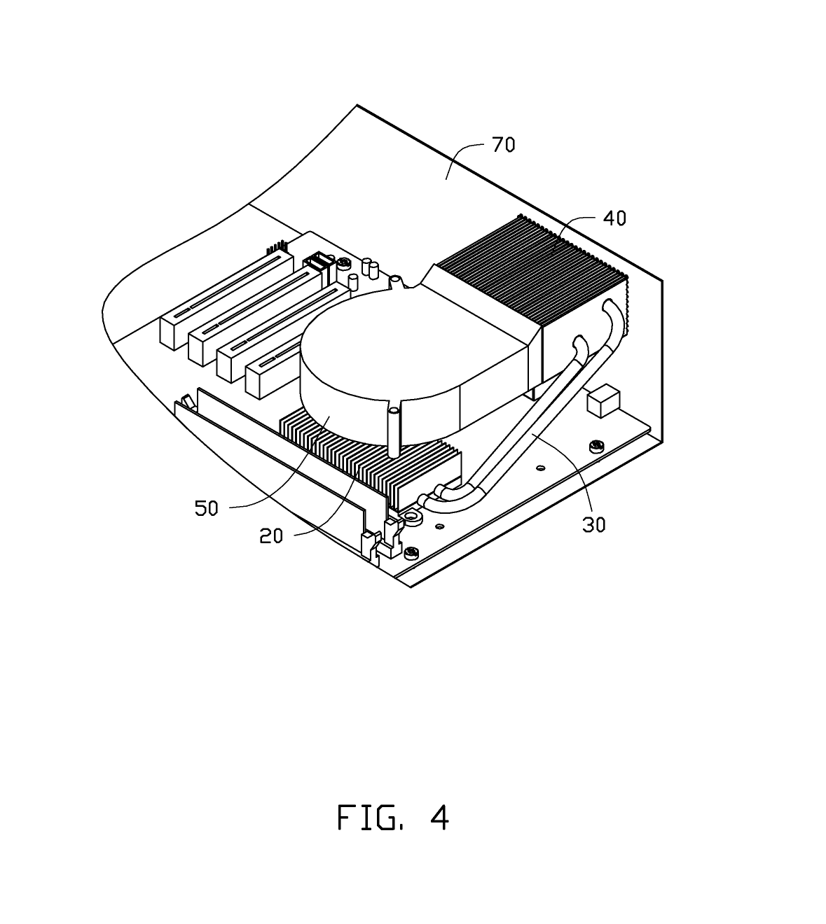

Referring to FIGS. 3 and 4, the heat dissipating apparatus 1 is installed in a host computer 60. The host computer 60 includes an enclosure 70 and a mainboard 80 mounted in the enclosure 70. The enclosure 70 defines an air hole 72. An electronic heat-generating component 82 is disposed on the mainboard 80. The electronic heat-generating component 82, may be, for example, a CPU.

The bottom surface of the base 10 contacts the top surface of the electronic heat-generating component 82. A side of the second fin assembly 40 opposite to the unidirectional fan module 50 communicates with the air hole 72 of the enclosure 70. The airflow from the unidirectional fan module 50 passes through the second fin assembly 40 and the heated airflow exits the enclosure 70 via the air hole 72.

It is to be understood, however, that even though numerous characteristics and advantages have been set forth in the foregoing description of embodiments, together with details of the structures and functions of the embodiments, the disclosure is illustrative only and changes may be made in detail, especially in the matters of shape, size, and arrangement of parts within the principles of the disclosure to the full extent indicated by the broad general meaning of the terms in which the appended claims are expressed.

What is claimed is:

1. A heat dissipating apparatus, comprising:
a base comprising a top surface and a bottom surface configured for contacting an electronic heat-generating component;
a first fin assembly disposed on the top surface of the base;
a second fin assembly separated from the first fin assembly; and
at least one heat pipe comprising a first contacting portion in contact with the base and a second contacting portion in contact with the second fin assembly.

2. The heat dissipating apparatus of claim 1, wherein the at least one heat pipe further comprises a connecting portion interconnecting the first contacting portion and the second contacting portion.

3. The heat dissipating apparatus of claim 2, wherein the first contacting portion, the second contacting portion, and the connecting portion are located in a plane inclined upward from the top surface of the base.

4. The heat dissipating apparatus of claim 3, wherein the at least one heat pipe is U-shaped.

5. The heat dissipating apparatus of claim 1, wherein at least one receiving groove is defined in the top surface of the base, and the first contacting portion of the at least one heat pipe is received in the at least one receiving groove.

6. The heat dissipating apparatus of claim 5, wherein at least one cutout groove is defined in a lower surface of the first fin assembly, the at least one receiving groove together with the at least one cutout groove define a receiving hole, and the first contacting portion of the at least one heat pipe is received in the receiving hole.

7. The heat dissipating apparatus of claim 1, wherein the first contacting portion of the at least one heat pipe is further in contact with the first fin assembly.

8. The heat dissipating apparatus of claim 1, wherein the second fin assembly is located in a horizontal position higher than the first fin assembly.

9. The heat dissipating apparatus of claim 1, wherein the second fin assembly defines at least one through hole, and the second contacting portion of the at least one heat pipe is received in the at least one through hole.

10. The heat dissipating apparatus of claim 1, further comprising a fan module coupled to the second fin assembly.

11. The heat dissipating apparatus of claim 10, wherein the fan module comprises an air outlet communicating a side of the second fin assembly.

12. The heat dissipating apparatus of claim 11, wherein the fan module is above the first fin assembly and spaced from the first fin assembly.

13. A host computer, comprising:
an enclosure defining an air hole;
a mainboard mounted in the enclosure;
an electronic heat-generating component disposed on the mainboard; and
a heating dissipating apparatus comprising:
a base comprising a top surface and a bottom surface in contact with the electronic heat-generating component;
a first fin assembly disposed on the top surface of the base;
a second fin assembly separated from the first fin assembly and comprising a first side communicating the air hole of the enclosure;
a unidirectional fan module comprising an air outlet coupled to a second side of the second fin assembly, the second side being opposite to the first side; and
at least one heat pipe comprising a first contacting portion in contact with the base and a second contacting portion in contact with the second fin assembly.

14. The host computer of claim 13, wherein the at least one heat pipe is located in a plane inclined upward from the top surface of the base.

15. The host computer of claim 13, wherein the at least one heat pipe is U-shaped.

16. The host computer of claim 13, wherein at least one receiving groove is defined in the top surface of the base, and the first contacting portion of the at least one heat pipe is received in the at least one receiving groove.

17. The host computer of claim 16, wherein at least one cutout groove is defined in a lower surface of the first fin assembly, the at least one receiving groove together with the at least one cutout groove define a receiving hole, and the first contacting portion of the at least one heat pipe is received in the receiving hole.

18. The host computer of claim 13, wherein the first contacting portion of the at least one heat pipe is further in contact with the first fin assembly.

19. The host computer of claim 13, wherein the second fin assembly is located in a horizontal position higher than the first fin assembly.

20. The host computer of claim 13, wherein the second fin assembly defines at least one through hole, and the second contacting portion of the at least one heat pipe is received in the at least one through hole.
